(19) United States
(12) Patent Application Publication
(10) Pub. No.: US 2011/0239523 A1
(43) Pub. Date: Oct. 6, 2011

(54) FISH HOOK AND LURE ADAPTER

(76) Inventor: RON W. BASKETT, San Bernardino, CA (US)

(21) Appl. No.: 13/049,885

(22) Filed: Mar. 16, 2011

Related U.S. Application Data
(60) Provisional application No. 61/318,830, filed on Mar. 30, 2010.

(51) Int. Cl. A01K 91/04

(52) U.S. Cl. 43/43.1

(57) ABSTRACT

A fish hook and lure adapter for attaching a fish hook or lure to a fishing line without tying a knot. The fish hook and lure adapter includes a shaft, a closed first eye at one end of the shaft for receiving a fish hook or lure, and an open second eye at the other end of the shaft. The shaft has a protrusion along its length. In operation a fishing line is formed into a loop, hooked onto the protrusion, wrapped around the shaft multiple times, feed through the second eye, and pulled to attach the fishing line to the fish hook and lure adapter.

### CROSS-REFERENCE TO RELATED APPLICATIONS

This application claims the benefit of U.S. Provisional Application No. 61/318,830 filed Mar. 30, 2010.

### FIELD OF THE INVENTION

The presently disclosed subject matter is directed towards a fish hook and lure adapter, and more particularly towards a fish hook and lure adapter for removably attaching a fish hook or lure to a fishing line without tying a knot.

### BACKGROUND OF THE INVENTION

Many people throughout the world enjoy fishing for recreation, sport, or consumption. While there are numerous ways to fish, one common method is to use fish hooks with either live or artificial bait or fishing lures that connect to a fishing line. As has been well established and documented by legions of fisherman, attaching hooks or lures to a fishing line can be both difficult and time consuming. This is particularly true in foul weather, when using thin fishing line, or when attempted by fisherman with poor eyesight or poor hand/eye coordination. In fact, many fishermen have been cut, impaled, or otherwise injured while attempting to attach a hook or lure to a fishing line.

Complicating the problems of attaching fishing hooks and lures to fishing lines is the need or desire to change hooks and lures often. This is because fish are notoriously finicky about what they will attack. At times, live bait is highly effective, at other times lures are more effective. In fact, a seemingly minor change in a fishing lure can dramatically improve the number of fish caught. Furthermore, what is effective one day may be counterproductive the next.

Thus there exists a need for a way to reduce the frustration and injuries associated with attaching a fish hook or lure to a fishing line. There is also a need to assist in changing fishing hooks and fishing lures without the need to tie knots.

### BRIEF SUMMARY OF THE INVENTION

The principles of the present invention provide for a device for assisting the attachment and detachment of fishing hooks and lures to fishing line. The principles of the present invention provide for a fish hook and lure adapter that enables rapid attachment and removal of fish hooks or lures from fishing lines without the difficulty of tying a knot.

A fish hook and lure adapter according to the principles of the present invention includes a shaft formed into a first eye at one end and into a second eye on the other end. Disposed on the shaft between the first and second eyes is a protrusion, beneficially configured as a ball, an anvil, a mushroom, or a short shaft.

To use the fish hook and lure adapter, a fishing line is doubled over to form a loop. That loop is then hooked around the protrusion, and the doubled over line is wrapped around the shaft to form a plurality of double wraps along with a remainder of doubled fishing line. That remainder is passed into the second eye and the doubled line is then pulled tightly along the axis of the shaft to tighten the doubled fishing line against the shaft. Tightening secures the fishing line to the shaft. A fishing hook or fishing lure is then attached to the first eye.

Beneficially, the first eye lies along a first plane while the shaft is twisted when forming the second eye such that the second eye lies along a second plane. Also beneficially the fishing hook or fishing lure is removably attached to the first eye. It is useful if the first eye is closed while the second eye is partially open. Alternatively, the first eye can be opened to receive a portion of the fishing hook or fishing lure and then closed.

### BRIEF DESCRIPTION OF THE DRAWINGS

The advantages and features of the present invention will become better understood with reference to the following detailed description and claims when taken in conjunction with the accompanying drawings, in which like elements are identified with like symbols, and in which:

FIG. 1 is an environmental perspective view of a fish hook and lure adapter 10 according to the principles of the present invention retaining a fishing lure 50;

FIG. 2 is an environmental perspective view of the fish hook and lure adapter 10 according to a preferred embodiment of the present invention retaining a fish hook 51;

FIG. 3A is a depiction of a first step of connecting a fishing line 15 to the fish hook and lure adapter 10;

FIG. 3B is a depiction of a second step of connecting a fishing line 15 to the fish hook and lure adapter 10,

FIG. 3C is a depiction of a third step of connecting a fishing line 15 to the fish hook and lure adapter 10; and

FIG. 3D is a depiction of a fourth step of connecting a fishing line 15 to the fish hook and lure adapter 10.

### DETAILED DESCRIPTION OF THE INVENTION

The presently disclosed subject matter now will be described more fully hereinafter with reference to the accompanying drawings in which one embodiment is shown. However, it should be understood that this invention may take many different forms and thus should not be construed as being limited to the embodiment set forth herein. In the figures like numbers refer to like elements throughout.

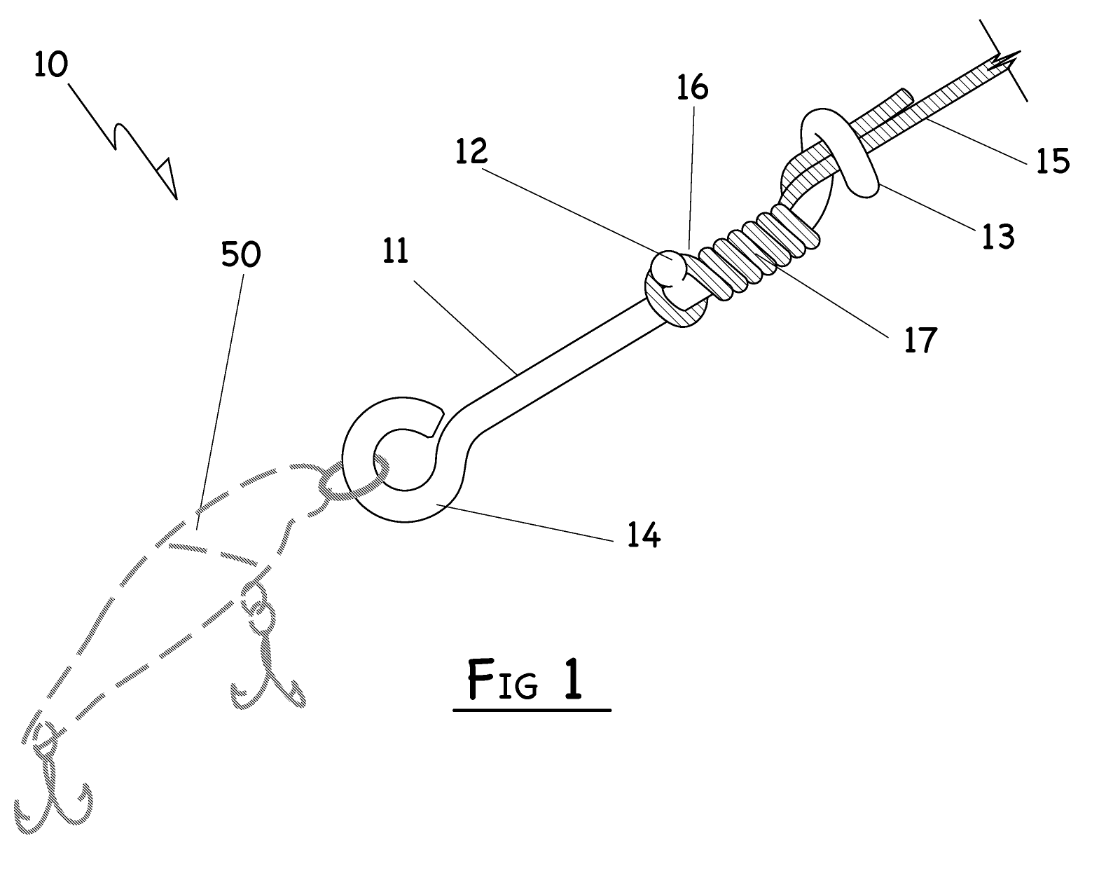

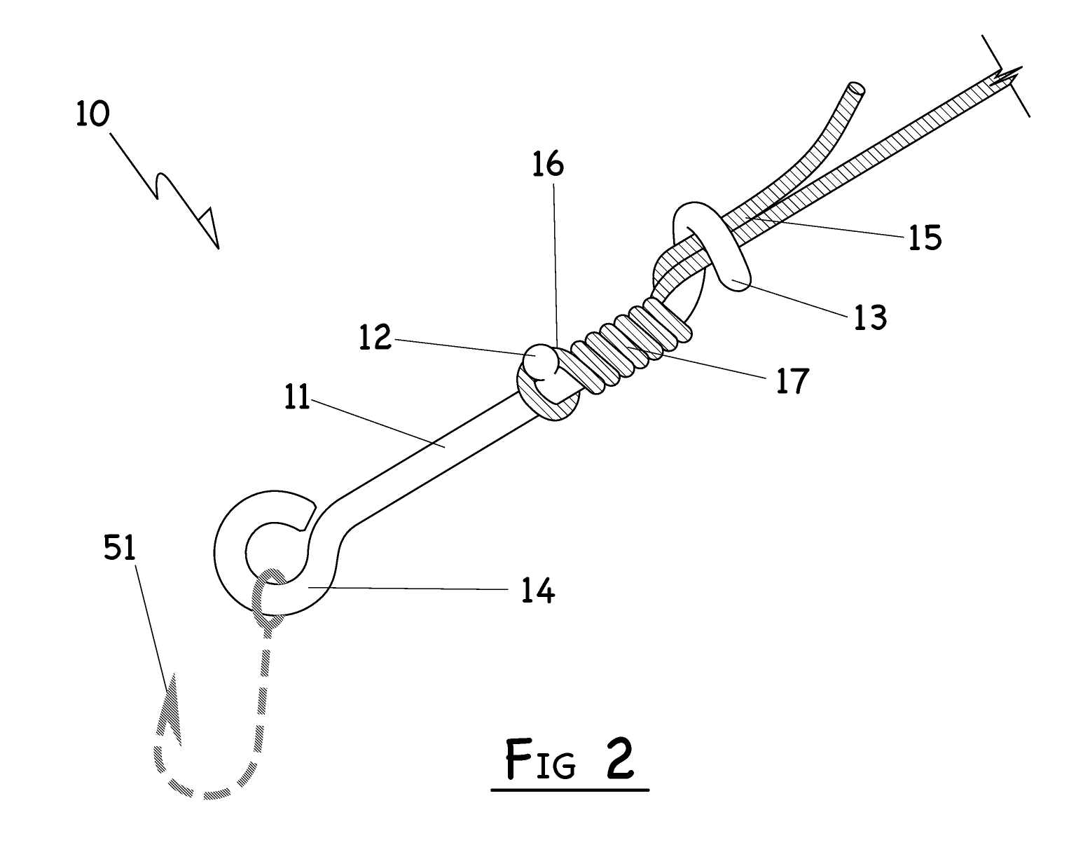

The principles of the present invention are described herein with reference to FIGS. 1 to 3D. Specifically, the principles of the present invention provide for a fish hook and lure adapter 10 that enables easy attachment and removal of a fishing hook 51 (see FIG. 2) or a lure 50 (see FIG. 1) to a fishing line 15 without tying a knot

Referring now to FIG. 1, a fish hook and lure adapter 10 comprises a shaft 11 having a small protrusion 12, such as a ball. The shaft 11 is formed into a closed first eye 14 at one end and into an open second eye 13 at the other. Beneficially the shaft 11 is twisted during the forming of the second eye 13 such that the first eye 14 and the second eye 13 lie in different planes. By open it is meant that the eye closes or almost closes on itself. By open it is meant that the eye does not close on itself, but that the fishing line can slide along the shaft 11 into the eye.

FIG. 2 illustrates the fish hook and lure adapter 10 of FIG. 1 attached to a fish hook 51.

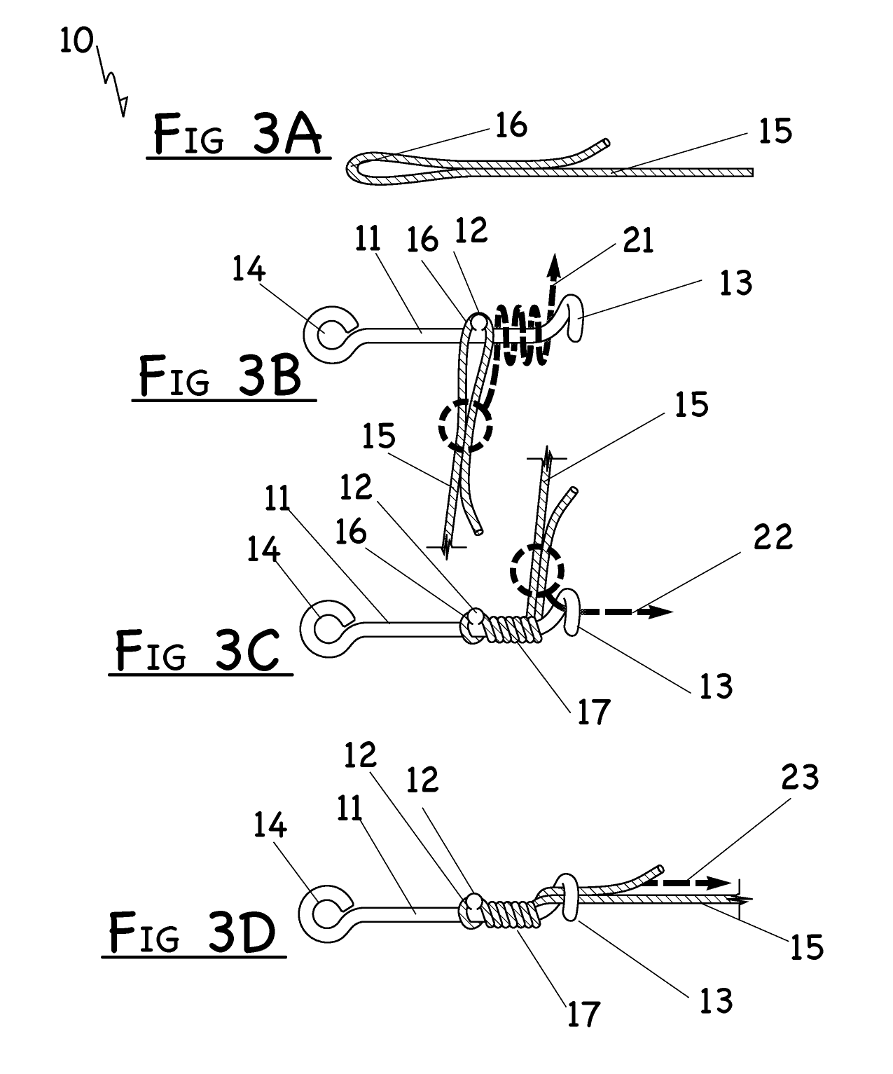

The use of the fish hook and lure adapter 10 is best described with the assistance of FIGS. 3A through 3D. First, a fishing line 15 is doubled over to form a loop 16, see FIG. 3A. The loop 16 is then hooked over the protrusion 12 and wrapped around the shaft 11 in a first direction 21 to form a plurality of wraps 17, see FIG. 3B. The doubled portion of the fishing line 15 remaining beyond the wraps 17 is then inserted into the second eye 13 and arranged along a second direction 22, see FIG. 3C. Finally, the fishing line 15 is pulled tightly along the axis 23 of the shaft 11 so as to tighten and secure the plurality of wraps 17 around the shaft 11, see FIG. 3D. The first eye 14 receives a lure 50 (FIG. 1) or a fishing hook (FIG. 2).

The fish hook and lure adapter 10 can be utilized by the common user in a simple and effortless manner with little or no training Furthermore, the fish hook and lure adapter 10 can be attached to a fish hook 51 or lure 50 before purchase by the end user. Alternatively, the fish hook 51 or lure 50 can come with a releasable eyelet attachment for easy attachment to the fish hook and lure adapter 10. Another approach would be for the end use to affix the fish hook and lure adapter 10 to his fish hook or lure by bending the first eye 14 around a fish hook 51 or lure 50 and then closing the eye.

Therefore, it is to be understood that while the figures and the above description illustrate the present invention, they are exemplary only. They are not intended to be exhaustive or to limit the invention to the precise forms disclosed, and obviously many modifications and variations are possible in light of the above teaching. Others who are skilled in the applicable arts will recognize numerous modifications and adaptations of the illustrated embodiments that remain within the principles of the present invention. Therefore, the present invention is to be limited only by the appended claims.

What is claimed:

1. A fish hook and lure adaptor for attaching a fish hook or lure to a fishing line, comprising:
a shaft having a first end that is formed into a first eye and a second end that is formed into a second eye; and
a protrusion disposed on the shaft between the first eye and the second eye;
wherein said protrusion, said shaft, and said second eye are configured to retain said fish hook and lure adaptor to a fishing line.

2. The adapter according to claim 1, wherein the first eye is configured to receive a fish hook or a fish lure.

3. The fish and lure adapter according to claim 1, wherein the shaft is twisted such that said first eye and said second eye line in different planes.

4. The fish and lure adapter according to claim 1, wherein said protrusion, said shaft, and said second eye are configured such that a doubled over fishing line can form a loop that hooks to said protrusion and can then be wrapped multiple times around said shaft, feed through said second eye, and tightened around said shaft by pulling so as to be held in place.

5. The fish and lure adapter according to claim 1, wherein a fish hook is attached to said first eye.

6. The fish and lure adapter according to claim 1, wherein a fish lure is attached to said first eye.
